(19) United States
(12) Patent Application Publication
(10) Pub. No.: US 2026/0301499 A1
(43) Pub. Date: Oct. 1, 2026

(54) AI-ENHANCED ACOUSTIC ANALYSIS SYSTEM FOR COIN AUTHENTICITY VERIFICATION AND COUNTERFEIT DETECTION USING CONVOLUTIONAL NEURAL NETWORKS AND SPECTROGRAM PROCESSING

(71) Applicant: Vincent Cheng, Burnaby (CA)

(72) Inventor: Vincent Cheng, Burnaby (CA)

(21) Appl. No.: 19/630,515

(22) Filed: Mar. 27, 2026

Related U.S. Application Data
(60) Provisional application No. 63/780,152, filed on Mar. 28, 2025.

(51) Int. Cl. G07D 5/00; G01N 25/20; G01N 29/44; H04L 9/32

(52) U.S. Cl. CPC G07D 5/00; G01N 25/20; G01N 29/4427; G01N 29/4481; H04L 9/32; G01N 2291/0234; G07D 2205/00

(57) ABSTRACT

A system, method, and computer-readable medium for authenticating coins using acoustic analysis and artificial intelligence. An acoustic signal acquisition module captures an acoustic signal generated when a coin is struck against a striking surface. A signal processing module generates a time-frequency spectrogram from the captured signal by applying a Short-Time Fourier Transform. A convolutional neural network trained on spectrogram images of known genuine and counterfeit coins extracts a feature vector from the spectrogram, and a machine learning classifier classifies the coin as genuine or counterfeit based on the extracted feature vector. Dynamic Time Warping alignment compensates for variations in striking conditions by aligning the test signal against a genuine reference signal and computing a deviation percentage score. A Peltier thermoelectric element applies a controlled thermal gradient to the coin and a temperature sensor measures the rate of heat transfer to provide supplementary thermal conductivity authentication.

### CROSS-REFERENCE TO RELATED APPLICATIONS

This application claims the benefit of U.S. Provisional Patent Application No. 63/780,152, filed Mar. 28, 2025, the entire disclosure of which is hereby incorporated by reference.

### FIELD OF INVENTION.

The present invention relates generally to systems and methods for detecting counterfeit coins using acoustic signal analysis, and more particularly to an artificial intelligence-driven authentication platform.

### BACKGROUND

The authentication of coins has long presented a technical challenge for institutions that handle currency in volume, including central banks, commercial banks, coin-operated machine manufacturers, and precious metal dealers. Counterfeit coins impose direct financial losses on these institutions and undermine public confidence in the monetary system. As counterfeiting techniques have grown in sophistication—particularly the advent of tungsten-core gold counterfeits whose weight and external dimensions closely replicate those of genuine coins—the limitations of existing authentication approaches have become increasingly apparent.

Traditional coin authentication methods fall broadly into three categories: visual inspection, electromagnetic sensing, and acoustic analysis. Visual inspection, whether performed by trained personnel or automated optical systems, is inherently limited to surface characteristics and cannot assess the internal material composition of a coin. Electromagnetic methods, which measure the electrical conductivity, magnetic permeability, or eddy current response of a coin as it passes through a sensor array, have been employed in coin-operated machines for several decades. For example, U.S. Pat. No. 5,485,908 to Greenwald et al. discloses a coin discrimination apparatus that passes coins through an electromagnetic sensor array and processes the resulting electrical and magnetic measurements using an artificial neural network to distinguish between coin denominations. While such electromagnetic approaches can identify denomination, they are principally concerned with sorting known coin types rather than detecting materially sophisticated counterfeits whose electromagnetic profiles may fall within the acceptance range of genuine coins. The sensing modality itself—eddy current and inductive measurement—provides no information about the acoustic resonance characteristics that are uniquely determined by a coin's internal metallurgical structure.

Acoustic analysis represents a fundamentally different sensing modality that probes the volumetric material properties of a coin rather than its surface or electromagnetic characteristics alone. When a coin is struck against a hard surface, the resulting acoustic signal contains resonant frequency components whose positions, magnitudes, and temporal decay profiles are determined by the coin's alloy composition, internal grain structure, density distribution, and physical dimensions. These acoustic properties are extremely difficult to replicate in a counterfeit, even when the external dimensions and weight of the counterfeit closely match those of a genuine coin.

Prior approaches to acoustic coin authentication have employed frequency-domain analysis of the captured signal but have relied on conventional signal processing techniques that extract only a limited set of predetermined features. European Patent Application Publication No. EP 1628267 A2 to Hess Cash Systems GmbH discloses a device and method for checking coins using acoustic analysis. That system excites a coin into mechanical vibration, captures the resulting acoustic signal via a microphone, and analyzes the signal using a Fast Fourier Transform to produce a power density spectrum. The system identifies the positions and magnitudes of frequency maxima within the spectrum and compares these values against stored reference data for known genuine coins. While EP 1628267 A2 establishes the general feasibility of acoustic frequency analysis for coin authentication, it employs a single-frame FFT that produces a static power spectrum. This approach captures only the frequency content present at a single point in time and discards the temporal evolution of that frequency content—specifically, how each resonant frequency diminishes at a rate characteristic of the coin's material composition during the acoustic decay. This temporal dimension is particularly important for detecting tungsten-core counterfeits, where the static frequency peaks may closely resemble those of a genuine coin but the decay profiles differ substantially due to the different internal damping characteristics of the core material. Moreover, EP 1628267 A2 relies entirely on deterministic comparison of frequency maxima against stored reference values, with no capacity for learned feature extraction, no classification model, and no ability to improve detection performance over time. The features selected for comparison are fixed at the time of system design.

Separately, the application of machine learning and deep learning techniques to acoustic signal classification has been explored in adjacent fields. Jiang et al., in a 2023 publication in Heritage Science, disclose a system for identifying ancient coins by their acoustic signatures using a deep learning platform. The system captures the sound produced when ancient coins are struck and uses a commercial deep learning service to classify the resulting audio signals, constructing an acoustic identifier for each coin type. However, that system operates as a black-box classifier on raw audio data, with no disclosed step of generating a time-frequency spectrogram via Short-Time Fourier Transform and then feeding that spectrogram representation into a convolutional neural network for feature extraction. The technical architecture of converting an acoustic signal into a two-dimensional spectrogram image and applying a CNN trained on spectrogram images of genuine and counterfeit coins—thereby enabling the network to learn complex spectro-temporal features that would not be apparent from raw audio or a static frequency spectrum—represents a fundamentally different pipeline from a black-box audio classification service. Additionally, the Jiang et al. system addresses identification of coin types for heritage conservation purposes rather than binary authenticity classification with quantified confidence metrics, and does not address compensation for variability in striking force, microphone placement, or environmental conditions.

More broadly, while convolutional neural networks have been applied to counterfeit detection in other domains—for example, U.S. Pat. No. 10,691,922 to Entrupy Inc. discloses a CNN-based system for detecting counterfeit items through analysis of visual and textual data on e-commerce platforms—these systems operate on entirely different input modalities and are not directed to acoustic coin authentication. The use of CNNs for image-based or text-based counterfeit detection does not teach or suggest the specific combination of acoustic signal capture, spectrogram generation, and CNN feature extraction from the spectrogram that characterizes the present invention.

None of the identified prior art, whether taken individually or in combination, discloses or suggests a system that compensates for acquisition variability by aligning a test acoustic signal with a reference signal using dynamic time warping, that provides supplementary material composition verification using LIDAR and spectral decay analysis, that stores and verifies cryptographic digital fingerprints of genuine coins on a permissioned blockchain, or that deploys federated learning across distributed device instances to continuously update the authentication model without transferring raw acoustic data between nodes. These features, both individually and in their integrated combination within a unified coin authentication platform, remain entirely unaddressed in the prior art.

It is within this context that the present invention is provided.

### SUMMARY OF INVENTION

The present invention addresses the foregoing deficiencies in the prior art by providing an integrated coin authentication system, method, and computer-readable medium that combine acoustic signal analysis with artificial intelligence to detect counterfeit coins with a degree of accuracy and adaptability unattainable by conventional approaches.

According to a first aspect of the present invention, a system for authenticating coins comprises an acoustic signal acquisition module comprising a microphone positioned to capture an acoustic signal generated when a coin is struck against a striking surface, a signal processing module communicatively coupled to the acoustic signal acquisition module and configured to receive the captured acoustic signal and generate a time-frequency spectrogram representation thereof by applying a Short-Time Fourier Transform to the captured acoustic signal, a feature extraction module communicatively coupled to the signal processing module and comprising a convolutional neural network trained on spectrogram images derived from acoustic signals of known genuine coins and known counterfeit coins, the convolutional neural network configured to receive the time-frequency spectrogram representation as an input image and extract a feature vector therefrom, and a classification module communicatively coupled to the feature extraction module and configured to receive the feature vector and classify the coin as genuine or counterfeit based on the extracted feature vector using a trained machine learning classifier.

In certain embodiments, the system further comprises a signal alignment module configured to perform Dynamic Time Warping alignment of the captured acoustic signal against a reference acoustic signal corresponding to a known genuine coin of the same denomination. The signal alignment module computes a deviation percentage score indicating a degree of temporal misalignment between the captured acoustic signal and the reference acoustic signal, and provides the deviation percentage score to the classification module as a supplementary input for the classifying. In further embodiments, the signal alignment module normalizes the captured acoustic signal and the reference acoustic signal to a common amplitude scale prior to performing the Dynamic Time Warping alignment, constructs a cost matrix representing pairwise distances between samples of the normalized signals, and determines an optimal warping path through the cost matrix that minimizes a cumulative alignment cost.

In certain embodiments, the system further comprises a blockchain verification module configured to generate a cryptographic hash of the extracted feature vector, store the cryptographic hash on a permissioned distributed ledger, and verify coin authenticity by comparing a cryptographic hash generated from a subsequently captured acoustic signal of the same coin against the stored cryptographic hash on the permissioned distributed ledger. The blockchain verification module provides a tamper-proof provenance record for each authenticated coin, enabling subsequent verification of the same coin without repeating the full acoustic classification pipeline.

In certain embodiments, the system further comprises a thermal conductivity analysis module comprising a Peltier thermoelectric element in thermal contact with a surface of the coin and a temperature sensor positioned to measure a temperature response of the coin. The thermal conductivity analysis module applies a controlled thermal gradient to the coin via the Peltier thermoelectric element and measures a rate of heat transfer through the coin over a predetermined time interval, and the classification module receives thermal conductivity data from the thermal conductivity analysis module and utilizes the thermal conductivity data as a supplementary input for the classifying. In further embodiments, the Peltier thermoelectric element operates in a bidirectional mode comprising a heating phase in which current is driven through the Peltier thermoelectric element in a first direction to heat the coin and a cooling phase in which the current is reversed to cool the coin, and the thermal conductivity analysis module generates a heating time-temperature profile and a cooling time-temperature profile, each indicative of a thermal diffusivity of a material composition of the coin. The bidirectional thermal profiling is particularly effective in distinguishing gold coins from tungsten-core counterfeits, because gold and tungsten exhibit substantially different thermal diffusivities despite having nearly identical densities, and the heating and cooling curves diverge in a manner that is readily detectable by the system. In certain embodiments, a mobile application executing on a mobile computing device communicates with the Peltier thermoelectric element and the temperature sensor, synchronizes initiation of a thermal test cycle with the Peltier thermoelectric element, simultaneously records temperature readings from the temperature sensor, and displays a time-stamped thermal response curve to the user for comparison against a stored reference thermal response curve corresponding to a genuine coin of the same denomination and material composition. In still further embodiments, the thermal conductivity analysis module is configured to authenticate precious metal bullion bars by applying the controlled thermal gradient to a surface of a bullion bar and measuring the rate of heat transfer through the bullion bar, the rate of heat transfer being indicative of an internal material composition of the bullion bar without requiring physical sectioning or melting of the bullion bar.

In certain embodiments, the system further comprises a federated learning module configured to update parameters of the convolutional neural network across a plurality of distributed authentication devices without transmitting raw acoustic data between the distributed authentication devices. Each of the distributed authentication devices computes local model gradients from locally captured acoustic signals and transmits the local model gradients to an aggregation server, and the aggregation server combines the local model gradients from the plurality of distributed authentication devices and distributes an updated global model to each of the distributed authentication devices. The federated learning architecture enables the system to improve its classification accuracy continuously as new counterfeit techniques are encountered in the field, while preserving user privacy by ensuring that no raw acoustic data is transmitted between devices.

According to a second aspect of the present invention, a method for authenticating a coin comprises capturing, via a microphone, an acoustic signal generated when the coin is struck against a striking surface, preprocessing the captured acoustic signal and generating a time-frequency spectrogram representation of the preprocessed acoustic signal by applying a Short-Time Fourier Transform thereto, inputting the time-frequency spectrogram representation as an image to a convolutional neural network trained on spectrogram images derived from acoustic signals of known genuine coins and known counterfeit coins and extracting a feature vector from the time-frequency spectrogram representation via the convolutional neural network, and classifying the coin as genuine or counterfeit based on the extracted feature vector using a trained machine learning classifier. In various embodiments, the method further comprises one or more of performing Dynamic Time Warping alignment and computing a deviation percentage score for use as a supplementary classification input, applying a controlled thermal gradient to the coin via a Peltier thermoelectric element and measuring a rate of heat transfer for use as a supplementary authentication input, generating a cryptographic hash of the extracted feature vector and storing the cryptographic hash on a permissioned distributed ledger for subsequent verification, and updating parameters of the convolutional neural network via federated learning across a plurality of distributed authentication devices.

According to a third aspect of the present invention, a non-transitory computer-readable medium stores instructions that, when executed by a processor, cause the processor to perform a method comprising receiving an acoustic signal captured by a microphone when a coin is struck against a striking surface, generating a time-frequency spectrogram representation of the acoustic signal by applying a Short-Time Fourier Transform thereto, providing the time-frequency spectrogram representation as an input image to a convolutional neural network trained on spectrogram images derived from acoustic signals of known genuine coins and known counterfeit coins and extracting a feature vector from the time-frequency spectrogram representation, and classifying the coin as genuine or counterfeit based on the extracted feature vector using a trained machine learning classifier.

The present invention thus provides a unified platform capable of authenticating coins and precious metal bullion through acoustic spectrogram analysis augmented by thermal conductivity verification, blockchain-based provenance tracking, and continuously improving machine learning models, deployable across dedicated hardware devices, mobile smartphones, and point-of-sale systems.

### BRIEF DESCRIPTION OF THE DRAWINGS

Various embodiments of the invention are disclosed in the following detailed description and accompanying drawings.

FIG. 1 is a block diagram illustrating the overall system architecture of the AI-enhanced acoustic analysis system for coin authenticity verification, showing the acoustic signal acquisition module, the signal processing module, the feature extraction module, the classification module, the blockchain verification module, and the federated learning module.

FIG. 2 is a detailed block diagram of the signal processing module of FIG. 1, showing the preprocessing sub-module, the Short-Time Fourier Transform spectrogram generation sub-module, the convolutional neural network feature extraction sub-module, the classification sub-module, and the training dataset.

FIG. 3 is a flow diagram illustrating the coin authentication method, including the steps of acoustic signal capture, preprocessing and spectrogram generation, convolutional neural network feature extraction, Dynamic Time Warping alignment, classification, blockchain verification, and federated learning model update.

FIG. 4 is a flow diagram illustrating the Dynamic Time Warping alignment process, including the steps of signal normalization, cost matrix construction, warping path determination, signal warping, deviation score computation, and threshold comparison to produce a consistency or inconsistency determination.

FIG. 5 is a block diagram illustrating the federated learning architecture, showing a plurality of distributed authentication devices each maintaining local training data and local model gradients, an aggregation server configured to combine the local model gradients, and a model validation module, with return paths distributing the updated global convolutional neural network model to each of the distributed authentication devices.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “spectrogram” refers to a two-dimensional representation of an acoustic signal in which one axis represents time, the other axis represents frequency, and the intensity or color of each point represents the magnitude of the signal at that particular time and frequency. A spectrogram is distinguished from a simple frequency spectrum or Fast Fourier Transform output in that it preserves the temporal evolution of frequency content across the duration of the captured signal, rather than collapsing the signal into a single time-independent frequency distribution.

As used herein, the term “Short-Time Fourier Transform” or “STFT” refers to a signal processing technique in which an acoustic signal is divided into successive overlapping segments, each segment is multiplied by a window function, and a Fourier Transform is applied to each windowed segment to produce a series of frequency-domain representations that, when assembled in sequence, form a spectrogram. The term encompasses any implementation in which overlapping windowed segments of a time-domain signal are individually transformed into the frequency domain and aggregated into a time-frequency matrix, regardless of the specific window function, window size, overlap ratio, or FFT point count employed.

As used herein, the term “convolutional neural network” or “CNN” refers to a class of artificial neural network comprising one or more convolutional layers, each of which applies a set of learnable filters to an input to produce feature maps, optionally followed by pooling layers that reduce the spatial dimensions of the feature maps, and one or more fully connected layers that produce an output representation. As used in the context of this specification, the convolutional neural network receives a spectrogram as a two-dimensional image input and produces a feature vector as output. The term is not limited to any particular number of layers, filter sizes, activation functions, or network depth.

As used herein, the term “feature vector” refers to a one-dimensional array of numerical values output by the convolutional neural network, each value representing the magnitude of a learned feature detected in the input spectrogram. The feature vector serves as a compressed numerical representation of the acoustic characteristics of the coin under test, suitable for input to a downstream classifier.

As used herein, the term “Dynamic Time Warping” or “DTW” refers to an algorithm that measures the similarity between two temporal sequences that may vary in speed or duration by computing an optimal alignment between the sequences. The algorithm constructs a cost matrix representing pairwise distances between all samples of the two sequences and determines a warping path through the cost matrix that minimizes the cumulative alignment cost, subject to continuity and boundary constraints. In the context of this specification, Dynamic Time Warping is applied to align a captured acoustic signal or feature sequence against a stored reference acoustic signal or feature sequence to compensate for variations in striking force, microphone placement, and environmental conditions.

As used herein, the term “deviation percentage score” refers to a numerical value, expressed as a percentage, derived from the cumulative alignment cost or residual distance computed during Dynamic Time Warping alignment, indicating the degree to which a test acoustic signal deviates from a reference acoustic signal. A deviation percentage score of zero indicates a perfect temporal alignment with the reference, and increasing values indicate progressively greater misalignment indicative of material or structural differences between the test coin and the reference coin.

As used herein, the term “Peltier thermoelectric element” refers to a solid-state device exploiting the Peltier effect, in which the passage of direct current through a junction of two dissimilar conductors or semiconductors causes heat to be transferred from one side of the junction to the other. Reversing the direction of current flow reverses the direction of heat transfer, such that the same element can function as both a heater and a cooler. As used in this specification, the Peltier thermoelectric element is employed to apply a controlled and reversible thermal gradient to a coin or bullion bar under test for the purpose of measuring thermal conductivity as an authentication parameter.

As used herein, the term “thermal diffusivity” refers to a material property defined as the ratio of thermal conductivity to the product of density and specific heat capacity, representing the rate at which a temperature disturbance propagates through a material. Gold and tungsten, despite having nearly identical densities of approximately 19.3 g/cm³ and 19.25 g/cm³ respectively, exhibit substantially different thermal diffusivities owing to their different thermal conductivities of approximately 318 W/m·K for gold and approximately 173 W/m·K for tungsten, and the present invention exploits this difference to distinguish genuine gold coins from tungsten-core counterfeits.

As used herein, the term “permissioned distributed ledger” refers to a blockchain or distributed ledger technology network in which participation is restricted to authorized nodes, such that only verified authentication devices or entities may read from or write to the ledger. The term is distinguished from a public or permissionless blockchain in which any participant may join without authorization. In this specification, the permissioned distributed ledger stores cryptographic hashes of acoustic feature vectors for subsequent provenance verification.

As used herein, the term “federated learning” refers to a machine learning training paradigm in which a model is trained across a plurality of decentralized devices, each holding local training data, without transferring the raw training data to a centralized server. Each device computes model parameter updates, referred to herein as local model gradients, based on its locally held data and transmits only the computed gradients to an aggregation server, which combines the gradients from all participating devices to produce an updated global model. The updated global model is then distributed back to each device. The term encompasses any aggregation strategy, including but not limited to federated averaging, in which the aggregation server computes a weighted average of local model parameters proportional to the number of training samples on each device.

Unless expressly stated otherwise, words such as “a,” “an,” and “the” are intended to include both singular and plural forms, and the term “about” is intended to accommodate ±10 % variations in stated values. Recitation of a range inherently includes all sub-ranges and individual values within that range. All exemplary materials, temperatures, and dimensions may be interchanged with other functionally equivalent counterparts unless contradicted by express language. The scope of the invention should therefore be construed in light of the appended claims, with these passages serving only to illustrate representative but non-limiting embodiments.

### DETAILED DESCRIPTION OF DRAWINGS

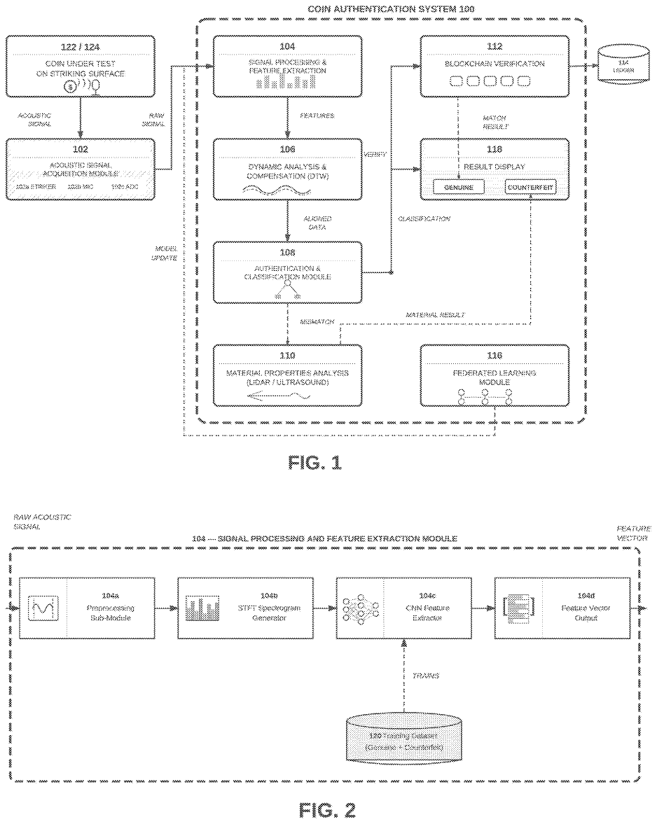

Referring now to FIG. 1, there is shown a block diagram of the overall architecture of a coin authentication system 100 in accordance with a preferred embodiment of the present invention. The coin authentication system 100 is depicted within a dashed boundary indicating the logical extent of the system, and comprises a plurality of interconnected modules that cooperate to receive an acoustic signal generated by striking a coin, process that signal through a series of analytical stages, and output a classification of the coin as genuine or counterfeit.

At the upper left of FIG. 1, a coin under test 122 is shown resting on a striking surface 124. The striking surface 124 is formed of a material having known and consistent acoustic properties, such as hardened aluminum or hardened steel, selected to minimize platform-induced variability in the acoustic signal produced when the coin under test 122 is struck. The striking surface 124 provides a repeatable acoustic coupling between the coin under test 122 and the remainder of the system, ensuring that variations in the resulting acoustic signal are attributable to differences in the coin itself rather than to differences in the striking medium. In a preferred embodiment, the striking surface 124 is a flat, rigid platform dimensioned to accommodate coins of varying diameters, from small denomination circulation coins through to large precious metal bullion coins.

An acoustic signal acquisition module 102 is positioned below the coin under test 122 and striking surface 124 in FIG. 1 and is communicatively coupled thereto by an acoustic signal path. The acoustic signal acquisition module 102 is responsible for detecting and digitizing the acoustic signal generated when the coin under test 122 is struck against the striking surface 124. The acoustic signal acquisition module 102 comprises three sub-components shown in abbreviated form within the module box: a striker 102a, a microphone 102b, and an analog-to-digital converter (ADC) 102c. The striker 102a is, in a preferred embodiment, a solenoid-activated striker arm configured to deliver a precisely calibrated impact force to the face of the coin under test 122. The solenoid is driven by a controlled direct current pulse of fixed duration and voltage, for example a 12V pulse of 50 ms duration, ensuring that substantially the same kinetic energy is delivered to the coin regardless of operator. The striker tip is formed of a hard, acoustically neutral material, such as hardened steel or ceramic, to avoid introducing material-specific resonances into the captured signal. In an alternative embodiment, the striker 102a is omitted and the user manually strikes or drops the coin against the striking surface 124, with the downstream Dynamic Time Warping module compensating for the resulting variability in strike force. The microphone 102b is a Micro-Electro-Mechanical Systems (MEMS) microphone having a substantially flat frequency response between approximately 1 kHz and approximately 40 kHz, positioned between approximately 5 mm and approximately 15 mm from the edge of the coin under test 122. MEMS microphones are selected for their consistent and flat frequency response across the target frequency range, their immunity to electromagnetic interference, their compact physical dimensions enabling integration into portable and handheld devices, and their ability to capture ultrasonic frequencies relevant to material resonance analysis. The ADC 102c operates at a minimum sampling rate of 88.2 kHz, which is at least double the Nyquist rate corresponding to the 40 kHz upper frequency of interest, with a safety margin to prevent aliasing artifacts. The ADC 102c converts the analog output of the microphone 102b into a digital audio stream, preferably at a resolution of 16-bit or 24-bit pulse-code modulation (PCM), and stores the digitized signal in a raw audio buffer. The total capture length is typically between 500 ms and 1000 ms, which is sufficient to capture the initial transient impact spike occurring in the first 1 to 5 ms, the primary resonance decay occurring between approximately 5 ms and 200 ms, and the full spectral tail extending from approximately 200 ms to 500 ms.

A data path indicated by an arrow labeled “RAW SIGNAL” connects the acoustic signal acquisition module 102 to a signal processing and feature extraction module 104, located in the upper center of FIG. 1. The signal processing and feature extraction module 104 receives the raw digitized acoustic signal from the acoustic signal acquisition module 102 and performs a series of signal processing and machine learning operations to transform the raw signal into a feature vector suitable for downstream classification. The internal architecture of the signal processing and feature extraction module 104 is described in detail below with reference to FIG. 2. An icon within the module 104 box in FIG. 1 depicts a series of vertical bars of varying heights, representing the spectrogram output that is generated as an intermediate product of the signal processing pipeline within module 104.

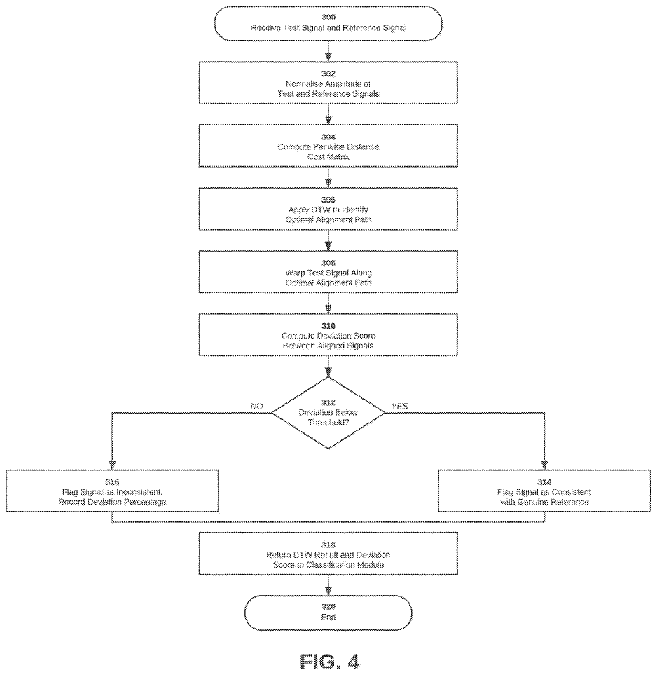

A data path indicated by an arrow labeled “FEATURES” connects the signal processing and feature extraction module 104 downward to a dynamic analysis and compensation module 106. The dynamic analysis and compensation module 106 implements the Dynamic Time Warping (DTW) algorithm described in the summary above and illustrated in detail in FIG. 4. The module 106 receives the feature vector or feature sequence output by module 104 and aligns it against a stored reference acoustic signal or feature sequence corresponding to a known genuine coin of the same denomination and material composition as the coin under test 122. The alignment compensates for temporal distortions introduced by variations in striking force, microphone placement, and environmental conditions, such that the downstream classifier receives a normalized and comparable input regardless of the specific conditions under which the acoustic signal was captured. An icon within the module 106 box depicts two overlaid waveforms, one solid and one dashed, representing the alignment of a test signal against a reference signal. The module 106 additionally computes a deviation percentage score indicating the degree of misalignment between the test signal and the reference signal after optimal warping; this score serves as an independent counterfeit indicator and is passed to the downstream classification stage as a supplementary input.

A data path indicated by an arrow labeled “ALIGNED DATA” connects the dynamic analysis and compensation module 106 downward to an authentication and classification module 108. The authentication and classification module 108 receives the aligned feature vector from module 106 together with the deviation percentage score and applies a trained machine learning classifier to produce a binary classification of the coin under test 122 as genuine or counterfeit, along with a confidence score expressed as a percentage. In a preferred embodiment, the primary classifier is the softmax output layer of the convolutional neural network within the signal processing and feature extraction module 104, which produces a probability distribution across the two classes. In an alternative embodiment, the classification module 108 employs an ensemble of classifiers comprising a support vector machine (SVM) with a radial basis function (RBF) kernel, a random forest of approximately 500 decision trees, and the convolutional neural network output, the three classifiers voting with weights proportional to their respective validation accuracies on a held-out test set. An icon within the module 108 box depicts a branching decision structure, representing the classification logic.

A data path indicated by an arrow labeled “CLASSIFICATION” connects the authentication and classification module 108 rightward to a result display 118, located in the right-center of FIG. 1. The result display 118 presents the authentication outcome to the user and comprises at least two display states: a “GENUINE” indication and a “COUNTERFEIT” indication, shown as two labeled output boxes within the result display 118 in FIG. 1. In a preferred embodiment, the result display 118 additionally presents the numerical confidence score and the deviation percentage score, enabling the user to assess the strength of the classification. The result display 118 may be implemented as a screen integrated into a dedicated hardware authentication device, as a display element within a mobile application executing on a smartphone, or as an output signal transmitted to a point-of-sale system or vending machine controller.

A branch point on the data path between the authentication and classification module 108 and the result display 118, indicated by a filled circle in FIG. 1, splits the data flow upward to a blockchain verification module 112, located in the upper right of FIG. 1. An arrow labeled “VERIFY” connects this branch point to the blockchain verification module 112. The blockchain verification module 112 generates a cryptographic hash of the extracted feature vector, preferably a SHA-256 hash incorporating both the spectral features and metadata associated with the coin under test 122 such as denomination and serial number. The blockchain verification module 112 communicates with a ledger 114, shown as a database cylinder to the right of module 112 in FIG. 1. The ledger 114 is a permissioned distributed ledger, such as a Hyperledger Fabric network, maintained across a plurality of authorized authentication nodes. The blockchain verification module 112 transmits the generated cryptographic hash to the ledger 114 for storage, or retrieves a previously stored cryptographic hash corresponding to the same coin for comparison. A dashed arrow labeled “MATCH RESULT” extends downward from the blockchain verification module 112 to the “GENUINE” indicator within the result display 118, representing the supplementary provenance confirmation that the blockchain verification module 112 provides when the generated hash matches the stored hash. In an embodiment in which the blockchain verification module 112 detects a mismatch between the generated hash and the stored hash despite a genuine classification from the authentication and classification module 108, the system flags the coin for manual review, as such a discrepancy may indicate a sophisticated counterfeit that replicates the acoustic properties of a genuine coin but does not possess the registered provenance record.

A dashed arrow labeled “MISMATCH” extends downward from the authentication and classification module 108 to a material properties analysis module 110, located at the bottom center of FIG. 1. The material properties analysis module 110 serves as a supplementary authentication pathway that is activated when the confidence score output by the authentication and classification module 108 falls below a predetermined threshold, or when the blockchain verification module 112 returns a mismatch. The material properties analysis module 110 comprises at least one of a LIDAR sensor configured to measure the surface topography of the coin under test 122 and an ultrasound sensor configured to measure the internal material density of the coin under test 122. In a further embodiment, the material properties analysis module 110 additionally or alternatively comprises a Peltier thermoelectric element in thermal contact with a surface of the coin under test 122 and a temperature sensor, such as an NTC thermistor, positioned to measure the temperature response of the coin as a controlled thermal gradient is applied. The Peltier thermoelectric element applies heat to the coin by driving current in a first direction, and subsequently cools the coin by reversing the current direction, generating both a heating time-temperature profile and a cooling time-temperature profile. The respective rates of heat transfer are indicative of the thermal diffusivity of the material composition of the coin, enabling discrimination between, for example, genuine gold coins and tungsten-core counterfeits that would otherwise be nearly indistinguishable by density measurement alone. A dashed arrow labeled “MATERIAL RESULT” extends from the material properties analysis module 110 rightward and upward to the “COUNTERFEIT” indicator within the result display 118, representing the supplementary classification outcome that the material analysis provides. An icon within the module 110 box depicts a directed beam and wave pattern, representing the sensing modalities employed.

A federated learning module 116 is located at the lower right of FIG. 1. The federated learning module 116 is responsible for continuously improving the convolutional neural network model employed by the signal processing and feature extraction module 104 across a plurality of distributed authentication devices, without requiring the transmission of raw acoustic data between devices. The federated learning module 116 operates by computing local model gradients on each distributed device based on locally captured acoustic signals whose authentication outcomes have been confirmed by user feedback or by secondary verification through the material properties analysis module 110 or the blockchain verification module 112, transmitting only those computed gradients to a central aggregation server, and receiving in return an updated global model. An icon within the module 116 box depicts a network of three connected node pairs, representing the distributed device network. A dashed feedback arrow labeled “MODEL UPDATE” extends from the federated learning module 116 downward to the bottom of FIG. 1, leftward along the bottom margin, and upward to rejoin the signal processing and feature extraction module 104, representing the distribution of updated model parameters back into the feature extraction pipeline.

Referring now to FIG. 2, there is shown a detailed block diagram of the internal architecture of the signal processing and feature extraction module 104 introduced in FIG. 1. The module 104 is depicted within a dashed boundary labeled “104—SIGNAL PROCESSING AND FEATURE EXTRACTION MODULE” and comprises four sub-modules arranged in a left-to-right processing pipeline, together with a training dataset repository that feeds into the pipeline.

At the left edge of FIG. 2, an arrow labeled “RAW ACOUSTIC SIGNAL” enters the system boundary from outside, representing the digitized acoustic signal received from the acoustic signal acquisition module 102 of FIG. 1. This arrow feeds into a preprocessing sub-module 104a, the first element in the pipeline. The preprocessing sub-module 104a receives the raw digitized acoustic signal and applies a sequence of conditioning operations to prepare the signal for spectrogram generation. In a preferred embodiment, the preprocessing operations comprise a digital bandpass filter, preferably a Butterworth filter of fourth order, with a low cutoff frequency of approximately 1,000 Hz to remove low-frequency handling noise and platform vibration, and a high cutoff frequency of approximately 40,000 Hz to remove ultrasonic noise above the range of relevant material resonance. The preprocessing sub-module 104a further performs DC offset removal by subtracting the mean value of the signal from every sample, eliminating any DC bias introduced by the microphone or ADC circuitry and ensuring the signal is centered at zero. A Hamming window function is then applied to the entire signal capture, tapering the signal amplitude at both temporal ends according to the function w(n)=0.54−0.46×cos(2πn/(N−1)), where N is the total number of samples, to reduce spectral leakage during the subsequent Fourier transform. An icon within the sub-module 104a box depicts a waveform flanked by dashed vertical boundary lines, representing the windowed signal.

An arrow connects the output of the preprocessing sub-module 104a rightward to an STFT spectrogram generator 104b, the second element in the pipeline. The STFT spectrogram generator 104b receives the preprocessed acoustic signal and generates a time-frequency spectrogram representation thereof by applying a Short-Time Fourier Transform. The preprocessed signal is divided into successive overlapping short segments, or frames, each of which is multiplied by a window function and transformed into the frequency domain using a Fast Fourier Transform. In a preferred embodiment, the window size is between 512 and 1024 samples, corresponding to approximately 5.8 ms to 11.6 ms at an 88.2 kHz sampling rate, with an overlap of approximately 75% between consecutive windows. The FFT size is between 1024 and 2048 points. The output of the STFT is a two-dimensional matrix in which the horizontal axis represents time, the vertical axis represents frequency, and the value at each point represents the magnitude of the signal at that frequency and time. This matrix is converted to a log-magnitude spectrogram image by applying a logarithmic scale to the frequency axis and expressing the amplitude in decibels. The resulting spectrogram image, typically of dimensions between 128×128 pixels and 512×512 pixels, is the direct input to the subsequent convolutional neural network. An icon within the sub-module 104b box depicts a series of vertical bars of varying heights and opacities, representing the frequency-domain content of the spectrogram.

An arrow connects the output of the STFT spectrogram generator 104b rightward to a CNN feature extractor 104c, the third element in the pipeline. The CNN feature extractor 104c comprises a convolutional neural network that receives the spectrogram image generated by the STFT spectrogram generator 104b as a two-dimensional input image and extracts a feature vector therefrom. In a preferred embodiment, the convolutional neural network comprises an input layer receiving a grayscale spectrogram image resized to a standard input dimension such as 224×224×1 pixels, followed by a plurality of convolutional layers each comprising a set of learnable filters applied to the input to produce feature maps. Each convolutional layer is followed by an activation function, preferably a Rectified Linear Unit (ReLU), and a max pooling layer that reduces the spatial dimensions of the feature maps while retaining the most prominent features. In one embodiment, the network comprises four such convolutional-pooling stages with progressively increasing filter counts of 32, 64, 128, and 256 filters respectively, each employing 3×3 kernels and 2×2 max pooling windows. The first convolutional layer detects basic edges and frequency bands in the spectrogram. The second layer detects combinations of frequency bands, resonance peaks, and harmonic relationships. The third layer detects temporal decay patterns characteristic of specific material compositions. The fourth layer detects high-level authenticity signatures representing complex combinations of resonance behavior, spectral decay rate, and harmonic structure. The output of the final pooling layer is flattened into a one-dimensional array and passed through one or more fully connected layers, preferably a first dense layer of 512 neurons with ReLU activation and 50% dropout, a second dense layer of 256 neurons with ReLU activation and 30% dropout, and an output layer of two neurons with softmax activation producing a probability distribution across the genuine and counterfeit classes. The one-dimensional array produced by the fully connected layers prior to the softmax output constitutes the feature vector. An icon within the sub-module 104c box depicts a network of interconnected nodes arranged in successive layers, representing the neural network architecture.

A dashed arrow labeled “TRAINS” extends upward from a training dataset 120 to the CNN feature extractor 104c. The training dataset 120 is shown as a database cylinder located below the processing pipeline within the dashed boundary of module 104, and is labeled “Training Dataset (Genuine+Counterfeit).” The training dataset 120 comprises a corpus of spectrogram images generated from acoustic signals of known genuine coins and known counterfeit coins across a plurality of coin denominations and material compositions. Each spectrogram image in the training dataset 120 is labeled as genuine or counterfeit, providing the supervised learning signal used to train the convolutional neural network of the CNN feature extractor 104c. The training dataset 120 is populated by capturing acoustic signals from coins of known provenance, processing each signal through the preprocessing sub-module 104a and the STFT spectrogram generator 104b to produce a labeled spectrogram image, and storing the labeled image in the dataset. The dashed style of the arrow from the training dataset 120 to the CNN feature extractor 104c indicates that the training data flow is a configuration-time operation rather than a real-time data path; during inference on a coin under test, no data flows from the training dataset 120.

An arrow connects the output of the CNN feature extractor 104c rightward to a feature vector output sub-module 104d, the fourth and final element in the pipeline. The feature vector output sub-module 104d receives the feature vector produced by the CNN feature extractor 104c and formats it for transmission to the downstream dynamic analysis and compensation module 106 and the authentication and classification module 108 of FIG. 1. An icon within the sub-module 104d box depicts a vertical array of horizontal bars enclosed in brackets, representing the numerical components of the feature vector. An arrow labeled “FEATURE VECTOR” exits the right edge of the system boundary of module 104, representing the output of the signal processing and feature extraction pipeline that is supplied to the remainder of the coin authentication system 100.

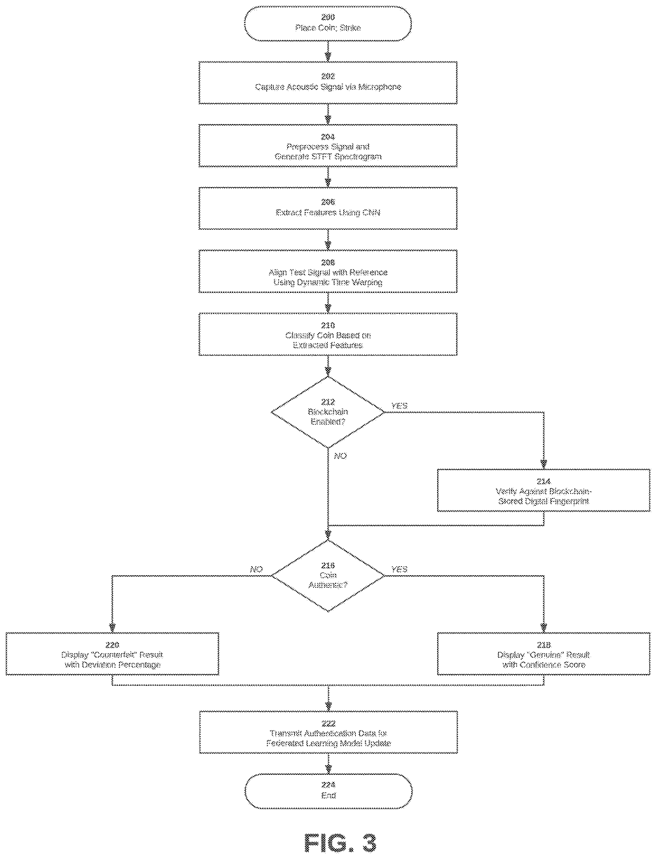

Referring now to FIG. 3, there is shown a flow diagram illustrating a method for authenticating a coin in accordance with a preferred embodiment of the present invention. The method proceeds through a series of sequential steps represented by process blocks, with two decision points represented by diamond-shaped decision blocks, and terminates at an end state. The flow follows a vertical central spine with branching paths at each decision point that extend laterally to subsidiary process blocks before rejoining the central spine.

The method begins at a start step 200, depicted as a pill-shaped terminator block at the top of FIG. 3 and labeled “Place Coin; Strike.” At step 200, a user places the coin under test on the striking surface and initiates a strike event, either by activating an automated solenoid striker or by manually striking or dropping the coin against the surface. The strike event generates an acoustic signal that propagates through the air and is detectable by the microphone of the acoustic signal acquisition module 102 described above with reference to FIG. 1.

An arrow leads downward from step 200 to step 202, labeled “Capture Acoustic Signal via Microphone.” At step 202, the microphone 102b captures the acoustic signal generated by the strike event and the ADC 102c digitizes the captured signal into a raw audio buffer as described above. The capture window encompasses the full duration of the acoustic event, including the initial transient impact spike, the primary resonance decay, and the spectral tail, typically spanning between 500 ms and 1000 ms of audio data.

An arrow leads downward from step 202 to step 204, labeled “Preprocess Signal and Generate STFT Spectrogram.” Step 204 encompasses two sequential operations that are grouped together as a single process step because both are performed within the signal processing and feature extraction module 104. First, the raw digitized acoustic signal is preprocessed by applying a bandpass filter to isolate frequencies within the range of approximately 1 kHz to 40 kHz, removing DC offset, and applying a Hamming window function, as described above with reference to the preprocessing sub-module 104a of FIG. 2. Second, the preprocessed signal is transformed into a time-frequency spectrogram by applying the Short-Time Fourier Transform, dividing the signal into overlapping windowed segments and computing the frequency-domain representation of each segment, as described above with reference to the STFT spectrogram generator 104b of FIG. 2. The output of step 204 is a two-dimensional log-magnitude spectrogram image representing the time-frequency content of the acoustic signal.

An arrow leads downward from step 204 to step 206, labeled “Extract Features Using CNN.” At step 206, the spectrogram image generated at step 204 is input to the convolutional neural network of the CNN feature extractor 104c described above with reference to FIG. 2. The convolutional neural network processes the spectrogram image through its successive convolutional, pooling, and fully connected layers and produces a feature vector as output. The feature vector is a compressed numerical representation of the acoustic characteristics of the coin under test, encoding the resonance behavior, spectral decay rates, harmonic relationships, and other material-dependent acoustic properties learned by the network during training on the training dataset 120.

An arrow leads downward from step 206 to step 208, labeled “Align Test Signal with Reference Using Dynamic Time Warping.” At step 208, the feature vector or feature sequence derived from the captured acoustic signal is aligned against a stored reference feature vector or feature sequence corresponding to a known genuine coin of the same denomination and material composition as the coin under test. The alignment is performed using the Dynamic Time Warping algorithm, which compensates for temporal distortions introduced by variations in striking force, microphone placement, and environmental conditions. The detailed sub-steps of the Dynamic Time Warping alignment process performed at step 208 are described in further detail below with reference to FIG. 4. The output of step 208 is an aligned feature vector and a deviation percentage score indicating the degree of temporal misalignment between the test signal and the reference signal.

An arrow leads downward from step 208 to step 210, labeled “Classify Coin Based on Extracted Features.” At step 210, the aligned feature vector from step 208, together with the deviation percentage score, is provided to the trained machine learning classifier of the authentication and classification module 108. The classifier produces a binary classification of the coin as genuine or counterfeit, together with a confidence score expressed as a percentage. In a preferred embodiment, the classification is derived from the softmax probability output of the convolutional neural network, optionally supplemented by an ensemble of additional classifiers as described above.

An arrow leads downward from step 210 to a first decision step 212, depicted as a diamond-shaped decision block labeled “Blockchain Enabled?” Decision step 212 determines whether the blockchain verification module 112 is active in the current configuration of the coin authentication system 100. Not all deployment environments require or support blockchain verification; for example, a standalone mobile application operating without network connectivity may bypass this step. If blockchain verification is not enabled, the flow follows the “NO” path directly downward along the central spine to a second decision step 216. If blockchain verification is enabled, the flow follows the “YES” path to the right to step 214.

Step 214 is labeled “Verify Against Blockchain-Stored Digital Fingerprint” and is located to the right of the central spine. At step 214, the system generates a cryptographic hash of the extracted feature vector and transmits the hash to the permissioned distributed ledger 114 via the blockchain verification module 112, which retrieves the previously stored hash corresponding to the same coin denomination and serial number and compares the two hashes. If the hashes match, the blockchain verification provides supplementary confirmation of the coin's authenticity and provenance. If the hashes do not match, this discrepancy is factored into the downstream authentication decision. A rejoin line extends from step 214 leftward back to the central spine, where the flow merges with the “NO” path from decision step 212 and proceeds downward to decision step 216.

Decision step 216 is depicted as a diamond-shaped decision block labeled “Coin Authentic?” and represents the final authentication decision point of the method. At step 216, the system evaluates the combined results of the CNN classification, the DTW deviation percentage score, and, if available, the blockchain verification outcome to determine whether the coin under test is genuine or counterfeit. If the coin is determined to be authentic, the flow follows the “YES” path to the right to step 218. If the coin is determined to be counterfeit, the flow follows the “NO” path to the left to step 220.

Step 218 is labeled “Display ‘Genuine’ Result with Confidence Score” and is located to the right of the central spine. At step 218, the result display 118 presents an indication that the coin has been classified as genuine, together with the numerical confidence score derived from the classifier output. The confidence score enables the user to assess the strength of the authentication—a confidence score approaching 100% indicates a high degree of certainty, whereas a lower confidence score may warrant further examination or supplementary testing through the material properties analysis module 110. A rejoin line extends from step 218 leftward back to the central spine.

Step 220 is labeled “Display ‘Counterfeit’ Result with Deviation Percentage” and is located to the left of the central spine. At step 220, the result display 118 presents an indication that the coin has been classified as counterfeit, together with the deviation percentage score computed during the DTW alignment at step 208. The deviation percentage score provides the user with a quantitative measure of how far the acoustic properties of the coin under test deviate from those of a known genuine coin, which may be useful for grading the severity or sophistication of the counterfeit. A rejoin line extends from step 220 rightward back to the central spine, where it merges with the rejoin line from step 218.

From the merge point of the rejoin lines below steps 218 and 220, an arrow leads downward to step 222, labeled “Transmit Authentication Data for Federated Learning Model Update.” At step 222, the authentication outcome and associated data—comprising the feature vector, the classification result, the confidence score, and the deviation percentage score—are transmitted to the federated learning module 116 for use in updating the convolutional neural network model. In a preferred embodiment, the system does not transmit the raw acoustic data; instead, only the computed model gradients derived from the local authentication outcome are transmitted to the aggregation server, as described above with reference to the federated learning module 116 of FIG. 1. This privacy-preserving approach ensures that the acoustic fingerprint of individual coins, which could contain information about the user's coin collection, is not exposed to the central server or to other devices in the network.

An arrow leads downward from step 222 to an end step 224, depicted as a pill-shaped terminator block at the bottom of FIG. 3 and labeled “End.” At step 224, the method terminates. The coin authentication system 100 is then ready to receive the next coin for authentication.

Referring now to FIG. 4, there is shown a flow diagram illustrating the Dynamic Time Warping alignment process that is performed at step 208 of the method of FIG. 3. The DTW alignment process receives as inputs a test acoustic signal captured from the coin under test and a reference acoustic signal corresponding to a known genuine coin of the same denomination and material composition, and produces as outputs an aligned test signal and a deviation percentage score. The process is performed within the dynamic analysis and compensation module 106 of FIG. 1.

The process begins at a start step 300, depicted as a pill-shaped terminator block at the top of FIG. 4 and labeled “Receive Test Signal and Reference Signal.” At step 300, the module 106 receives the test signal, which may be the raw preprocessed acoustic signal or the feature sequence extracted by the CNN feature extractor 104c, and a corresponding reference signal retrieved from a database of known genuine coin signatures maintained by the system. The reference signal is selected to match the denomination and material composition of the coin under test, ensuring that the alignment is performed against the correct baseline.

An arrow leads downward from step 300 to step 302, labeled “Normalise Amplitude of Test and Reference Signals.” At step 302, both the test signal and the reference signal are normalized to a common amplitude scale. Normalization removes amplitude variations caused by differences in striking force, microphone distance, and environmental noise levels, ensuring that the subsequent distance computations in the DTW algorithm reflect differences in the temporal structure and spectral content of the signals rather than differences in their overall loudness. In a preferred embodiment, normalization comprises scaling each signal such that its peak amplitude equals unity, although other normalization strategies such as root-mean-square normalization may alternatively be employed.

An arrow leads downward from step 302 to step 304, labeled “Compute Pairwise Distance Cost Matrix.” At step 304, the system constructs a two-dimensional cost matrix representing the pairwise distances between every sample of the normalized test signal and every sample of the normalized reference signal. If the test signal comprises n samples and the reference signal comprises m samples, the cost matrix is an n×m matrix in which the element at position (i,j) represents the distance between the i-th sample of the test signal and the j-th sample of the reference signal. The distance metric is, in a preferred embodiment, the Euclidean distance, although other metrics such as the absolute difference or the squared difference may alternatively be used. The cost matrix captures the full landscape of similarity relationships between all possible pairings of test and reference samples, providing the input from which the optimal alignment path is subsequently computed.

An arrow leads downward from step 304 to step 306, labeled “Apply DTW to Identify Optimal Alignment Path.” At step 306, the Dynamic Time Warping algorithm is applied to the cost matrix computed at step 304 to determine the optimal warping path through the matrix. The optimal warping path is the sequence of matrix elements from the element (1,1) in the upper-left corner to the element (n,m) in the lower-right corner that minimizes the cumulative sum of the distances along the path, subject to continuity constraints requiring that each step in the path advances by at most one position along each axis and boundary constraints requiring that the path begins at (1,1) and ends at (n,m). The computation is typically performed using dynamic programming, building up the cumulative cost matrix from the starting element and tracing the minimum-cost path backward from the terminal element. The resulting path defines a mapping between each sample of the test signal and one or more samples of the reference signal, accounting for any temporal stretching, compression, or warping between the two signals.

An arrow leads downward from step 306 to step 308, labeled “Warp Test Signal Along Optimal Alignment Path.” At step 308, the test signal is warped along the optimal alignment path determined at step 306. Each sample of the test signal is mapped to the corresponding sample or samples of the reference signal as defined by the warping path, producing a temporally aligned version of the test signal in which the timing of the acoustic events—the initial transient, the resonance peaks, and the spectral decay—corresponds to the timing of the same events in the reference signal. The warped test signal is directly comparable to the reference signal on a sample-by-sample basis, enabling the computation of a meaningful deviation metric in the subsequent step.

An arrow leads downward from step 308 to step 310, labeled “Compute Deviation Score Between Aligned Signals.” At step 310, the system computes a deviation score between the warped test signal and the reference signal. The deviation score is derived from the residual distance between the two signals after optimal alignment—that is, the remaining differences that cannot be accounted for by temporal warping alone and that therefore reflect genuine differences in the spectral content or material properties of the coin under test relative to the genuine reference. The deviation score is expressed as a deviation percentage, where a score of zero percent indicates a perfect match with the reference signal and increasing values indicate progressively greater divergence. In a preferred embodiment, the deviation percentage is computed as the cumulative DTW distance normalized by the length of the warping path and expressed as a percentage of the maximum expected deviation for the coin denomination in question.

An arrow leads downward from step 310 to a decision step 312, depicted as a diamond-shaped decision block labeled “Deviation Below Threshold?” Decision step 312 compares the deviation percentage score computed at step 310 against a predetermined threshold value. The threshold is calibrated during system training and represents the maximum deviation that is consistent with normal variation among genuine coins of the same denomination and composition, accounting for expected variability in striking conditions and environmental factors. If the deviation percentage score is below the threshold, the flow follows the “YES” path to the right to step 314. If the deviation percentage score is at or above the threshold, the flow follows the “NO” path to the left to step 316.

Step 314 is labeled “Flag Signal as Consistent with Genuine Reference” and is located to the right of the central spine. At step 314, the DTW module flags the test signal as consistent with the genuine reference, indicating that the temporal and spectral characteristics of the coin under test fall within the expected range for a genuine coin. This consistency flag is a positive indicator that is passed to the classification module as a supplementary input. A rejoin line extends from step 314 leftward back to the central spine.

Step 316 is labeled “Flag Signal as Inconsistent, Record Deviation Percentage” and is located to the left of the central spine. At step 316, the DTW module flags the test signal as inconsistent with the genuine reference, indicating that the acoustic properties of the coin under test deviate from the expected range by an amount exceeding the threshold. The system records the specific deviation percentage as a quantitative measure of the inconsistency. An inconsistency flag, together with the numerical deviation percentage, is passed to the classification module as a supplementary input that weighs against a genuine classification. A rejoin line extends from step 316 rightward back to the central spine, where it merges with the rejoin line from step 314.

From the merge point, an arrow leads downward to step 318, labeled “Return DTW Result and Deviation Score to Classification Module.” At step 318, the dynamic analysis and compensation module 106 packages the outputs of the DTW alignment process—comprising the consistency or inconsistency flag, the deviation percentage score, and the warped test signal—and returns them to the authentication and classification module 108 of FIG. 1 for use in the final classification decision at step 210 of the method of FIG. 3. The DTW result serves as an independent authentication signal that supplements the CNN-based classification, providing the system with two complementary lines of evidence: the CNN evaluates the spectral content of the signal, and the DTW evaluates its temporal alignment with a known genuine reference.

An arrow leads downward from step 318 to an end step 320, depicted as a pill-shaped terminator block at the bottom of FIG. 4 and labeled “End.” At step 320, the DTW alignment sub-process terminates and control returns to the calling method of FIG. 3 at step 208.

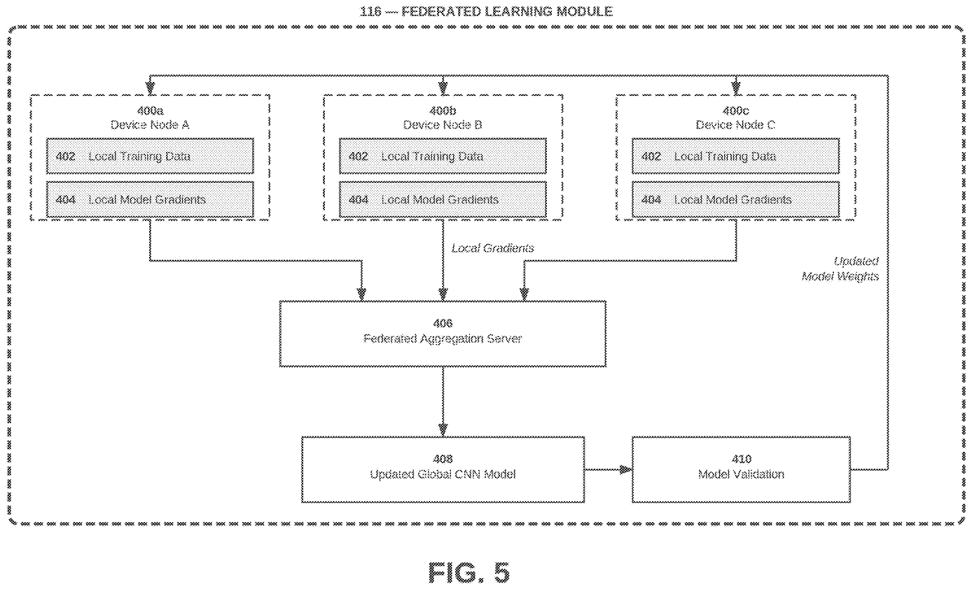

Referring now to FIG. 5, there is shown a block diagram illustrating the architecture of the federated learning module 116 introduced in FIG. 1. The module 116 is depicted within a dashed boundary labeled “116—FEDERATED LEARNING MODULE” and comprises a plurality of distributed device nodes, a central aggregation server, a global model output, and a model validation stage, interconnected by gradient transmission paths and model distribution return paths.

At the top of FIG. 5, three device nodes 400a, 400b, and 400c are arranged in a horizontal row, each depicted as a dashed-border container representing an individual coin authentication device deployed in the field. Device node A 400a is positioned at the left, device node B 400b at the center, and device node C 400c at the right. Although three device nodes are shown for purposes of illustration, it will be understood that the federated learning architecture of the present invention is not limited to three devices and may encompass any number of distributed authentication devices participating in the learning network. Each device node represents an instance of the coin authentication system 100 described above with reference to FIG. 1, operating independently at a separate physical location and processing coins through the acoustic-spectrogram-CNN pipeline.

Each of the device nodes 400a, 400b, and 400c contains two internal sub-blocks depicted as shaded rectangles. The first sub-block within each device node is labeled 402, “Local Training Data.” The local training data 402 comprises the corpus of spectrogram images and associated authentication outcomes that have been accumulated locally on that particular device during its operation. As each device authenticates coins and receives confirmation of the outcomes—whether through user feedback, secondary verification via the material properties analysis module 110, or blockchain verification via the blockchain verification module 112—the confirmed spectrogram-label pairs are stored locally as training data 402. The local training data 402 is never transmitted to other devices or to the central server, ensuring that potentially sensitive information about the coins processed at each location remains private.

The second sub-block within each device node is labeled 404, “Local Model Gradients.” The local model gradients 404 are computed by each device node by performing one or more training iterations on the local training data 402 using the current version of the convolutional neural network model. During each training iteration, the device feeds its locally stored spectrogram images through the network, computes the classification error with respect to the known labels, and back-propagates that error through the network to produce gradient updates for each layer's weights and biases. These gradient updates constitute the local model gradients 404. The local model gradients 404 represent the direction and magnitude of the parameter adjustments that would improve the model's performance on the local data, without revealing the underlying spectrogram images or authentication outcomes from which they were derived.

Arrows extend downward from each of the three device nodes to a federated aggregation server 406, located in the center of FIG. 5 below the device nodes. The arrow from the central device node 400b proceeds directly downward to the aggregation server 406. The arrows from the left device node 400a and the right device node 400c each follow an elbow path, proceeding downward from the respective device node and then turning horizontally inward to meet the aggregation server 406, with the arrow from device node 400a entering the aggregation server 406 at its left quarter point and the arrow from device node 400c entering at its right quarter point. A label “Local Gradients” is positioned alongside these arrows to indicate the nature of the data being transmitted. The federated aggregation server 406 receives the local model gradients 404 from each participating device node and combines them to produce a single set of aggregated gradient updates. In a preferred embodiment, the aggregation is performed using federated averaging, in which the server computes a weighted average of the local model parameters from each device, with the weights proportional to the number of training samples held by each device, according to the formula Global_weights=Σ(nk/n)×Local_weights_k, where nk is the number of training samples on device k and n is the total number of training samples across all devices. Other aggregation strategies, including secure aggregation protocols that prevent the server from inspecting individual device contributions, may alternatively be employed.

An arrow extends downward from the federated aggregation server 406 to an updated global CNN model 408, located below the server in FIG. 5. The updated global CNN model 408 represents the new version of the convolutional neural network that incorporates the learning from all participating device nodes. The aggregation server 406 applies the aggregated gradient updates to the current global model parameters to produce the updated global CNN model 408. This updated model reflects the collective knowledge of the entire distributed network—including any new counterfeit types encountered by any device at any location—without any single device having shared its raw acoustic data.

An arrow extends to the right from the updated global CNN model 408 to a model validation module 410, positioned to the right of the global model in FIG. 5. The model validation module 410 evaluates the performance of the updated global CNN model 408 against a held-out validation dataset to confirm that the aggregated updates have improved, or at minimum not degraded, the model's classification accuracy. Validation metrics may include overall classification accuracy, false positive rate, false negative rate, and per-denomination performance metrics. If the updated model passes validation, it is approved for distribution to the device nodes. If the updated model fails validation—for example, if a corrupted gradient submission from a malfunctioning device has degraded performance—the aggregation server 406 may discard the update, revert to the previous model version, or exclude the offending device's contribution and re-aggregate.

A return path extends from the model validation module 410 to each of the device nodes 400a, 400b, and 400c. The return path is depicted in FIG. 5 as a solid line that proceeds rightward from the model validation module 410 to a vertical rail along the right side of the diagram, ascends along that rail to the top of FIG. 5, turns leftward and extends horizontally across the full width of the diagram above the device nodes, and drops vertically downward into each of the three device nodes 400a, 400b, and 400c, terminating with an arrowhead at the top edge of each node. A label “Updated Model Weights” is positioned alongside the ascending portion of the return path. The return path delivers the validated updated global CNN model 408 to each device node, replacing the previous local copy of the model with the new global version. Each device node then uses the updated model for subsequent coin authentication operations, and the cycle repeats as new local training data 402 is accumulated and new local model gradients 404 are computed.

The federated learning architecture depicted in FIG. 5 provides two key advantages. First, it enables the coin authentication system 100 to improve continuously over time as new counterfeit techniques are encountered at any location in the distributed network, because the learning from each device is shared with all other devices through the aggregated model updates. A sophisticated counterfeit detected at a single retail location, for example, immediately strengthens the detection capability of every other device in the network once the next aggregation cycle completes. Second, it preserves the privacy of the data processed at each device, because only the mathematical gradient updates—not the raw acoustic signals, spectrogram images, or authentication outcomes—are transmitted between the devices and the aggregation server. This privacy-preserving property is particularly important in commercial deployment contexts where the coins being authenticated may be associated with specific users, transactions, or inventory records that the device operator would not wish to disclose.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for authenticating coins, comprising:
an acoustic signal acquisition module comprising a microphone positioned to capture an acoustic signal generated when a coin is struck against a striking surface;
a signal processing module communicatively coupled to the acoustic signal acquisition module, the signal processing module configured to receive the captured acoustic signal and generate a time-frequency spectrogram representation thereof by applying a Short-Time Fourier Transform to the captured acoustic signal;
a feature extraction module communicatively coupled to the signal processing module, the feature extraction module comprising a convolutional neural network trained on spectrogram images derived from acoustic signals of known genuine coins and known counterfeit coins, the convolutional neural network configured to receive the time-frequency spectrogram representation as an input image and extract a feature vector therefrom; and
a classification module communicatively coupled to the feature extraction module, the classification module configured to receive the feature vector and classify the coin as genuine or counterfeit based on the extracted feature vector using a trained machine learning classifier.

2. The system of claim 1, further comprising a signal alignment module configured to perform Dynamic Time Warping alignment of the captured acoustic signal against a reference acoustic signal corresponding to a known genuine coin of the same denomination, the signal alignment module further configured to compute a deviation percentage score indicating a degree of temporal misalignment between the captured acoustic signal and the reference acoustic signal, wherein the deviation percentage score is provided to the classification module as a supplementary input for the classifying.

3. The system of claim 2, wherein the signal alignment module is configured to normalize the captured acoustic signal and the reference acoustic signal to a common amplitude scale prior to performing the Dynamic Time Warping alignment, construct a cost matrix representing pairwise distances between samples of the normalized captured acoustic signal and the normalized reference acoustic signal, and determine an optimal warping path through the cost matrix that minimizes a cumulative alignment cost.

4. The system of claim 1, further comprising a blockchain verification module configured to generate a cryptographic hash of the extracted feature vector, store the cryptographic hash on a permissioned distributed ledger, and verify coin authenticity by comparing a cryptographic hash generated from a subsequently captured acoustic signal of the same coin against the stored cryptographic hash on the permissioned distributed ledger.

5. The system of claim 1, further comprising a thermal conductivity analysis module comprising a Peltier thermoelectric element in thermal contact with a surface of the coin and a temperature sensor positioned to measure a temperature response of the coin, the thermal conductivity analysis module configured to apply a controlled thermal gradient to the coin via the Peltier thermoelectric element and measure a rate of heat transfer through the coin over a predetermined time interval, wherein the classification module is further configured to receive thermal conductivity data from the thermal conductivity analysis module and utilize the thermal conductivity data as a supplementary input for the classifying.

6. The system of claim 5, wherein the Peltier thermoelectric element is configured to operate in a bidirectional mode comprising a heating phase in which current is driven through the Peltier thermoelectric element in a first direction to heat the coin and a cooling phase in which the current is reversed to cool the coin, and wherein the thermal conductivity analysis module is configured to generate a heating time-temperature profile and a cooling time-temperature profile, each indicative of a thermal diffusivity of a material composition of the coin.

7. The system of claim 1, further comprising a federated learning module configured to update parameters of the convolutional neural network across a plurality of distributed authentication devices without transmitting raw acoustic data between the distributed authentication devices, wherein each of the distributed authentication devices computes local model gradients from locally captured acoustic signals and transmits the local model gradients to an aggregation server, and wherein the aggregation server combines the local model gradients from the plurality of distributed authentication devices and distributes an updated global model to each of the distributed authentication devices.

8. The system of claim 5, further comprising a mobile application executing on a mobile computing device, the mobile application in communication with the Peltier thermoelectric element and the temperature sensor, the mobile application configured to synchronize initiation of a thermal test cycle with the Peltier thermoelectric element and simultaneously record temperature readings from the temperature sensor, and to display a time-stamped thermal response curve to a user of the mobile computing device for comparison against a stored reference thermal response curve corresponding to a genuine coin of the same denomination and material composition.

9. The system of claim 5, wherein the thermal conductivity analysis module is further configured to authenticate precious metal bullion bars by applying the controlled thermal gradient to a surface of a bullion bar via the Peltier thermoelectric element and measuring the rate of heat transfer through the bullion bar, the rate of heat transfer being indicative of an internal material composition of the bullion bar without requiring physical sectioning or melting of the bullion bar.

10. A method for authenticating a coin, comprising:
capturing, via a microphone, an acoustic signal generated when the coin is struck against a striking surface;
preprocessing the captured acoustic signal and generating a time-frequency spectrogram representation of the preprocessed acoustic signal by applying a Short-Time Fourier Transform thereto;
inputting the time-frequency spectrogram representation as an image to a convolutional neural network trained on spectrogram images derived from acoustic signals of known genuine coins and known counterfeit coins, and extracting, via the convolutional neural network, a feature vector from the time-frequency spectrogram representation; and
classifying the coin as genuine or counterfeit based on the extracted feature vector using a trained machine learning classifier.

11. The method of claim 10, further comprising performing Dynamic Time Warping alignment of the captured acoustic signal against a reference acoustic signal corresponding to a known genuine coin of the same denomination, and computing a deviation percentage score indicating a degree of temporal misalignment between the captured acoustic signal and the reference acoustic signal, wherein the classifying further comprises utilizing the deviation percentage score as a supplementary input to the trained machine learning classifier.

12. The method of claim 10, further comprising applying a controlled thermal gradient to the coin via a Peltier thermoelectric element in thermal contact with a surface of the coin, measuring a temperature response of the coin over a predetermined time interval using a temperature sensor, and determining a rate of heat transfer through the coin from the measured temperature response, wherein the classifying further comprises utilizing the determined rate of heat transfer as a supplementary authentication input.

13. The method of claim 10, further comprising generating a cryptographic hash of the extracted feature vector and storing the cryptographic hash on a permissioned distributed ledger, and verifying authenticity of the coin upon subsequent presentation by comparing a newly generated cryptographic hash against the stored cryptographic hash.

14. The method of claim 12, wherein applying the controlled thermal gradient comprises positioning the coin on an edge thereof such that heat travels along a full diameter of the coin, driving current through the Peltier thermoelectric element in a first direction for a first time period to heat the coin, reversing the current through the Peltier thermoelectric element for a second time period to cool the coin, and generating a heating time-temperature profile and a cooling time-temperature profile, each indicative of a thermal diffusivity of a material composition of the coin, wherein a difference in thermal diffusivity between gold and tungsten produces a measurable temporal separation between genuine and counterfeit thermal response profiles.

15. The method of claim 10, further comprising updating parameters of the convolutional neural network via federated learning across a plurality of distributed authentication devices, comprising computing local model gradients at each of the distributed authentication devices from locally captured acoustic signals, transmitting the local model gradients to an aggregation server without transmitting raw acoustic data, combining the local model gradients at the aggregation server, and distributing an updated global model from the aggregation server to each of the distributed authentication devices.

16. The method of claim 12, further comprising synchronizing, via a mobile application executing on a mobile computing device, initiation of a thermal test cycle with the Peltier thermoelectric element and simultaneous recording of temperature readings from the temperature sensor, and displaying a time-stamped thermal response curve on the mobile computing device for comparison against a stored reference thermal response curve corresponding to a genuine coin of the same denomination and material composition.

17. A non-transitory computer-readable medium storing instructions that, when executed by a processor, cause the processor to perform a method comprising:
receiving an acoustic signal captured by a microphone when a coin is struck against a striking surface;
generating a time-frequency spectrogram representation of the acoustic signal by applying a Short-Time Fourier Transform thereto;
providing the time-frequency spectrogram representation as an input image to a convolutional neural network trained on spectrogram images derived from acoustic signals of known genuine coins and known counterfeit coins, and extracting, via the convolutional neural network, a feature vector from the time-frequency spectrogram representation; and
classifying the coin as genuine or counterfeit based on the extracted feature vector using a trained machine learning classifier.

18. The non-transitory computer-readable medium of claim 17, wherein the method further comprises performing Dynamic Time Warping alignment of the acoustic signal against a reference acoustic signal corresponding to a known genuine coin of the same denomination and computing a deviation percentage score, and wherein the classifying utilizes the deviation percentage score as a supplementary classification input.

19. The non-transitory computer-readable medium of claim 17, wherein the method further comprises receiving thermal conductivity data generated by applying a controlled thermal gradient to the coin via a Peltier thermoelectric element and measuring a temperature response of the coin using a temperature sensor, and wherein the classifying further utilizes the thermal conductivity data as a supplementary authentication input.

20. The non-transitory computer-readable medium of claim 17, wherein the method further comprises updating parameters of the convolutional neural network via federated learning across a plurality of distributed authentication devices by aggregating local model gradients at an aggregation server without transmitting raw acoustic data between the distributed authentication devices.
